(19) United States
(12) Patent Application Publication
(10) Pub. No.: US 2026/0076865 A1
(43) Pub. Date: Mar. 19, 2026

(54) PERSONAL CARE DEVICE

(71) Applicant: Carrasco Enterprises, Inc., San Antonio, TX (US)

(72) Inventor: Amulfo T. Carrasco, San Antonio, TX (US)

(73) Assignee: Carrasco Enterprises, Inc., San Antonio, TX (US)

(21) Appl. No.: 19/328,772

(22) Filed: Sep. 15, 2025

Related U.S. Application Data
(60) Provisional application No. 63/694,567, filed on Sep. 13, 2024.

(51) Int. Cl. A61H 15/00; A61H 39/04

(52) U.S. Cl. CPC A61H 15/0092; A61H 39/04; A61H 2015/0042; A61H 2201/105; A61H 2201/1635

(57) ABSTRACT

Disclosed herein are personal care devices and methods of using such devices to assist individuals in reaching all locations on the individual's body to perform specific helpful functions at those locations on the body. In one embodiment, a personal care device includes a head portion located at a first end of the device and a spherical feature located at a second and opposite end of the device, with the head portion and spherical feature connected by an extended handle. The head portion includes a first side with a generally cylindrical recess arranged to accommodate and secure at least two sizes of roll-on applicator and a second and opposite side with a flat surface arrange to accommodate and secure a pad applicator. The spherical feature is arranged to apply pressure to specific locations on the body to deploy beneficial acupressure or other massage theory to such locations on the body.

### CROSS REFERENCE TO RELATED APPLICATION

The present application claims priority to U.S. provisional application Ser. No. 63/694,567, titled “Personal Care Device,” filed Sep. 13, 2024, which is fully hereby incorporated by reference herein.

### FIELD OF INVENTION

The present disclosure generally relates to personal care devices and methods of using such personal care devices to assists individuals in day-to-day personal care tasks. More specifically, the present disclosure relates to a multi-functional personal care device that includes functionality and methods of using such personal care devices to assists an individual in performing multiple disparate common personal care tasks that require the individual to access locations on the individual's body that are difficult to reach.

### BACKGROUND

Personal care devices are products that assist individuals in accomplishing common tasks that are beneficial to the health and well-being of the individual. Personal care devices span a broad range both in types of devices and in the functionality of the devices. In one example, certain personal care devices are products that assist an individual in common personal hygiene tasks such as bathing, showering, brushing one's teeth, and other similar tasks. In another example, certain personal care devices are products that monitor the heath of individuals such at thermometers, blood glucose monitors, blood pressure monitor, heart rate monitor, and the like. These are but two examples of categories of personal care devices available in the marketplace for consumers and healthcare organizations.

This present disclosure is directed to personal care devices that assist an individual in accessing locations or regions of the human body that are difficult to reach for a variety or reasons. There are certain locations on the human body that are difficult to reach for all individuals because of the nature of human anatomy. For example, nearly all individuals have difficulty reaching between the shoulder blades and a section of the upper back that extends from the midpoint of the shoulder blades downward toward the small of the back. Whether reaching over the shoulder or around the side of the body, most humans cannot access this region. It is a challenge for any individual to massage this area or apply topical liquids, gels or other substance to this section of the back.

Additionally, for certain individuals, advanced age, medical conditions, injuries, generally inflexibility, and the like can cause difficulty reaching numerous locations on the human body. In one example, individuals with arthritis and lower back stiffness often have limited flexibility and mobility making it difficult to reach the lower back, the back of the legs, and lower extremities such as the lower legs and feet. If such an individual desires to apply a substance, such as a pain relief solution, to the lower back or put on socks and shoes, the limited flexibility and mobility may make these impossible tasks.

To address such needs, many personal care devices have been developed and are available in the marketplace. However, the present selection of personal care products directed at assisting individuals to perform and accomplish self-care tasks are generally directed to a single dedicated and narrow task. If an individual desires to accomplish multiple personal care tasks at or to multiple locations on the individual's body, the individual needs to acquire and use multiple individual personal care devices or forego some of the desired personal care tasks. The present personal care devices on the market do not sufficiently serve consumers' needs.

Therefore there is a need in the marketplace for personal care devices that assist individuals in reaching all locations on the human body to accomplish multiple functions and personal care tasks. As described herein, such personal care devices can be arranged to not only accomplish multiple tasks, but to also provide a quality user experience. Disclosed herein are such personal care devices and methods of using such personal care devices.

### SUMMARY

Disclosed herein are personal care devices and methods of using such device to assist individuals in reaching all locations on the individual's body to perform specific helpful functions and personal care tasks. In one embodiment, a personal care device includes a head portion located at a first end of the device, a spherical feature located at a second and opposite end of the device, with the head portion and spherical feature connected by an extended handle.

The head portion includes a first side with a generally cylindrical recess and a second and opposite side with a flat surface. The cylindrical recess includes a first inner section with a first inner diameter and a second inner section with a second inner diameter. The first inner diameter is of a different size as compared to the second inner diameter. The first inner diameter is arranged to secure an object with a cylindrical body at least partially within the cylindrical recess. In this instance, such an object has an outer diameter that matches the first inner diameter of the cylindrical recess such that a friction fit secures the object at least partially within the cylindrical recess. The second inner diameter is arranged to secure a different object with a cylindrical body at least partially within the cylindrical recess. In this instance, such a different object has an outer diameter that matches the second inner diameter in the cylindrical recess such that a friction fit secures the object at least partially withing the cylindrical recess. It will be understood that only one object will be secured in the cylindrical recess at any given time. The different first and second inner diameters of the cylindrical recess provide for options for a user of the personal care device to secure different sized objects in the cylindrical recess. In one embodiment, the cylindrical objects to be secured in the cylindrical recess are commercially available roll-on applicators arranged to topically apply a beneficial substance to the human body. In one non-limiting example, the beneficial substance is a pain relief solution.

The flat surface of the second side of the head portion is arranged such that a pad applicator can be secured to the flat surface. In one example, the pad applicator can be removably secured to the flat surface using a tacky adhesive that adequately secures the pad applicator to the flat surface for use but the pad applicator can be removed from the flat surface with sufficient applied force and cleaned for subsequent reattachment and use or optionally subsequently discarded after use. In an example of a disposable pad applicator, the pad applicator can be a separately acquired component that includes an adhesive on one side covered by a non-stick sheet to form a “peel and stick” arrangement. The non-stick sheet is removed when the user is preparing to use the pad applicator, and the pad applicator is secured to the flat surface of the head. In another example, the pad applicator is integrally incorporated into or on to the head portion and the pad applicator is cleaned between uses. Prior to use, a liquid, gel, lotion, cream, or other fluid substance can be applied to the pad applicator. The liquid, gel, lotion, or cream can be the type of substance that is intended to be applied topically to the human body and provide a benefit to the human body. In one non-limiting example, the beneficial substance is a pain relief solution.

The personal care device is arranged so that a user can engage the spherical feature at a location on the human body that is sore, achy, experiencing muscle spasms, or otherwise needs attention. The spherical feature, typically a ball integrated into the end of the extended handle, is engaged with the human body at a desired location by applying an appropriate force to deliver beneficial acupressure or other massage theory to that location on the human body. Such delivery of acupressure or other massage therapy is not limited to only hard to reach locations on the human body, such delivery of acupressure or other massage therapy can be applied to any location on the body.

The extended handle connecting the head portion and the spherical feature has an ergonomic design with a double-curved shape and features to assist a user with grasping and holding the personal care device during use and effectively using the personal care device. The extended handle includes a first grip section located proximate to the head portion and a second grip section located proximate to the spherical feature. To use the head portion of the personal care device to apply a substance to the human body via a roll-on applicator or an applicator pad, a user grips the second grip section of the handle and maneuvers and extends the personal care device until the head portion is at the desired location on the user's body. The beneficial substance is then topically applied to the desired location on the user's body. To apply acupressure or other massage therapy to a location on the user's body via the spherical feature, a user grips the first grip section of the handle and maneuvers and extends the personal care device until the spherical feature is at the desired location on the user's body. The user than engages the spherical feature with the desired section of the body and applies appropriate pressure to deliver acupressure or other massage therapy to the desired location on the body. The double-curved shape of the handle assists a user in positioning a roll-on applicator, applicator pad, or the spherical feature at a beneficial angle to the body of the user so as to assist the user is applying medication or pressure as desired to address the needs of the user.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates a top-left perspective view of an embodiment of a personal care device.

FIG. 2 schematically illustrates a bottom-left perspective view of the embodiment of the personal care device of FIG. 1.

FIG. 3 schematically illustrates a side view of the embodiment of the personal care device of FIG. 1.

FIG. 4 schematically illustrates a top view of the embodiment of the personal care device of FIG. 1.

FIG. 5 schematically illustrates a bottom view of the embodiment of the personal care device of FIG. 1.

FIG. 6 schematically illustrates an enhanced section identified in FIG. 2 of the extended handle of the embodiment of the personal care device of FIG. 1.

FIG. 6A schematically illustrates a raised area identified in FIG. 6.

FIG. 7 schematically illustrates an enhanced section identified in FIG. 1 of the head portion of the embodiment of the personal care device of FIG. 1.

FIG. 8 schematically illustrates a cross-sectional view of the head portion of the embodiment of the personal care device of FIG. 1.

FIG. 9 schematically illustrates a cross-sectional view of an alternative head portion for use with the embodiment of the personal care device of FIG. 1.

FIG. 10 schematically illustrates a cross-sectional view of another alternative head portion for use with the embodiment of the personal care device of FIG. 1.

FIG. 11 schematically illustrates a bottom-left perspective view of a pad applicator secured to the head portion of the embodiment of the personal care device of FIG. 1.

FIG. 12 schematically illustrates a side view of a pad applicator secured to the head portion of the embodiment of the personal care device of FIG. 1.

FIG. 13A schematically illustrates a front view of a pad applicator for use with personal care devices disclosed herein.

FIG. 13B is a side view of the pad applicator of FIG. 13A.

FIG. 14 schematically illustrates an alternative head portion for use with the embodiment of the personal care device of FIG. 1.

FIG. 15 schematically illustrates an enhanced section identified in FIG. 4 of a portion of the extended handle of the embodiment of the personal care device of FIG. 1.

FIG. 16 schematically illustrates an enhanced section identified in FIG. 1 of a spherical feature of the embodiment of the personal care device of FIG. 1.

### DETAILED DESCRIPTION

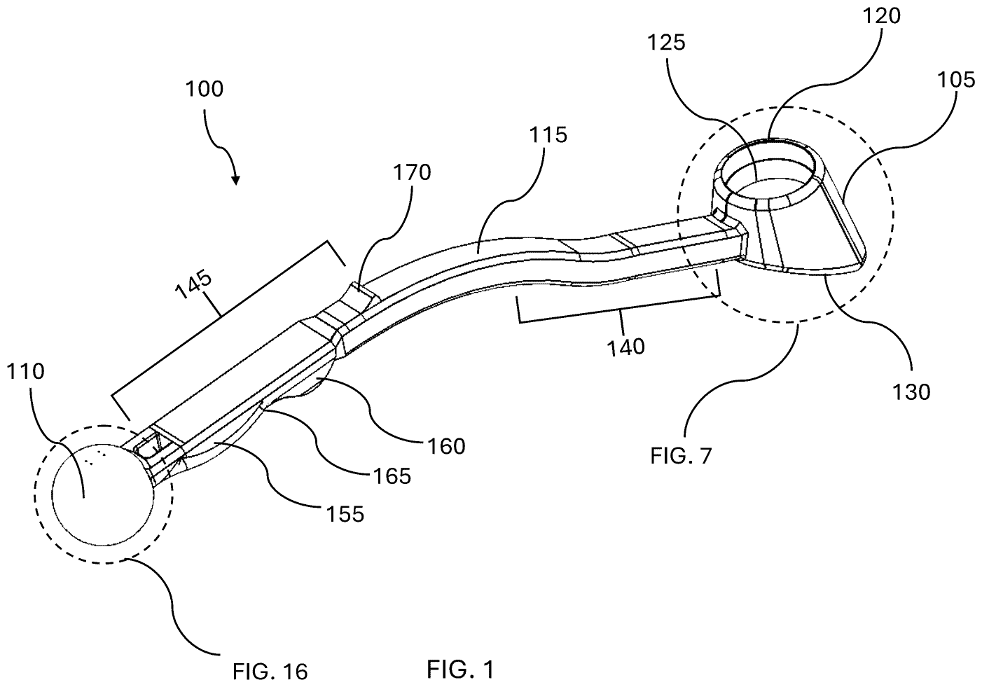

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected embodiments and examples of multifunctional personal care devices for performing common self-care tasks are hereinafter disclosed and described in detail with reference made to FIGS. 1 through 16.

The present disclosure describes personal care devices and method of using same. Generally, embodiments of personal care devices disclosed herein are reuseable devices that can include functionality for removably securing objects, such as a roll-on type applicator, to one end of the personal care device and securing a replaceable, reuseable, and/or disposable pad applicator to the same end of the personal care device. Such personal care devices can also include, on the opposite end of the personal care device, a feature for users to apply pressure on parts of the human body for therapeutic purposes. The personal care devices disclosed herein can include an ergonomic double-curved handle to assist users in applying a beneficial substance or therapeutic pressure to the body of the user. The double-curved handle is designed to allow users to comfortably and securely grip and use the personal care device. This includes users that have limited use of their hands such as limited ability to achieve closure of the hand (i.e., making a fist around an object) and/or generally lacking dexterity and/or strength in the hands. The double-curved handle, with one curve of the handle curving in one direction and another curve of the handle curving in the opposite direction, provides a user with better reach and angles at which to apply ointment either with a roll-on applicator or pad applicator and to engage the body with the spherical feature.

The personal care device can further be useful in other personal care tasks such as reaching an itch and scratching or otherwise soothing the itching area through contact with any part of the personal care device with the itching area. Among many others, the personal care device is appliable for concerns and conditions such as applying pain relieve ointment or medication, attending to a number of skin conditions, such as dryness, shingles, gout, eczema, psoriasis, and any other skin condition that can be address by the application of an ointment or medication.

More specifically, certain embodiments of personal care devices can be arranged to provide a user of the device with access to all locations on the body, for example, the hard to reach area of a person's back between the shoulder blades, the area below the shoulder blades, the neck, areas of the upper back, and lower legs including the calves, shins, ankles, and soles of the feet. Once a certain location on the human body is accessed by a user, the personal care device facilitates a useful function such as performing a self-care task. Throughout this disclosure, most examples of a personal care device will be described with reference to a roll-on applicator and a pad applicator for applying an ointment or medication such as a pain relief solution to hard to reach locations on the body and using a spherical feature of the personal care device to apply acupressure or other massage therapy to any location on the human body. While this disclosure generally describes the performance of certain specific functions and tasks, it will be understood that the embodiments described herein are but examples of personal care devices and methods of using such personal care device and can be modified to perform many other functions and tasks that are beneficial to the user of a personal care device.

Disclosed herein are several embodiments of a multi-purpose personal care device that includes the structures and features to perform at least the following functions: (i) provide for multiple methods for applying a liquid, gel, cream, lotion, or other fluid substance to hard to reach locations on the human body, including application of substances with a roll-on applicator and/or a pad applicator; (ii) provide for a method of applying acupressure or other massage therapy techniques to any location on the human body to alleviate soreness, achiness, spasmatic muscle contractions, knots, and the like; and (iii) provide an ergonomic double-curved handle for ease of use of the personal care device by all users and accommodate varying hand sizes and hand strength. In one embodiment, the personal care device is arranged to apply, for example, topical pain relief solutions; creams and lotions to attend to skin issues such as dry skin and psoriasis; sun tanning solutions and lotions; liquid soap for bathing; and any other such substance that is useful for applying topically to the human body.

The design of the personal care device provides a user with an option to choice how to apply substances to the body based on personal preference, i.e., roll-on applicator or pad applicator, without the need for multiple devices. In addition to the application of fluids and acupressure to locations on the human body, the personal care device can be adapted to perform a variety of other functions, such as, for example, attaching a mechanism to assist a user in putting on socks; attaching a shoe horn to assist a user in putting on shoes; attaching a mechanism that assists the user in putting on or taking off a shirt or other clothing and garments; attaching a back scratcher or using the personal care device itself as a back scratcher; attaching a hair brush or comb for assisting a user with grooming hair; and attaching a mechanism that functions as a reacher or grabber to assist the user with retrieving items that are out of reach to the user.

In essence, the personal care device provides a sense of freedom to users, who no longer need to rely on friends, family, and caregivers to access all locations on the individual's body to conduct common personal care tasks. For certain individuals that are at an advanced age or suffer for a medical condition or injury, it can be difficult if not impossible to access not only the region between the shoulder blades, but also the low back, neck, hips, legs and feet. In these cases, the personal care device significantly extends a user's range of motion to perform many self-care tasks without the assistance of others.

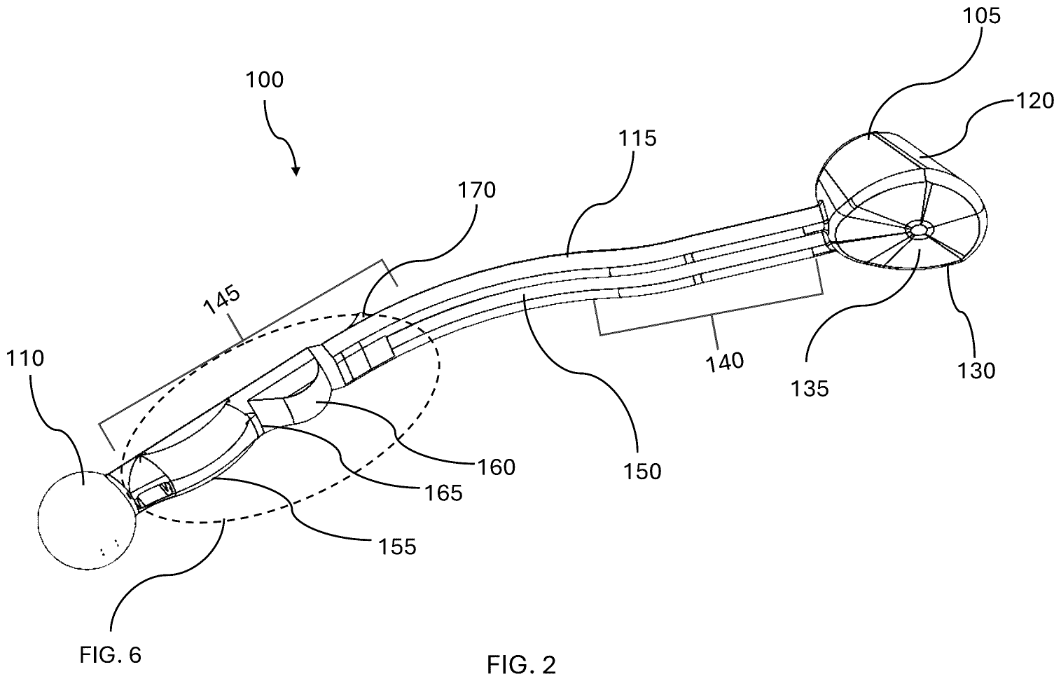

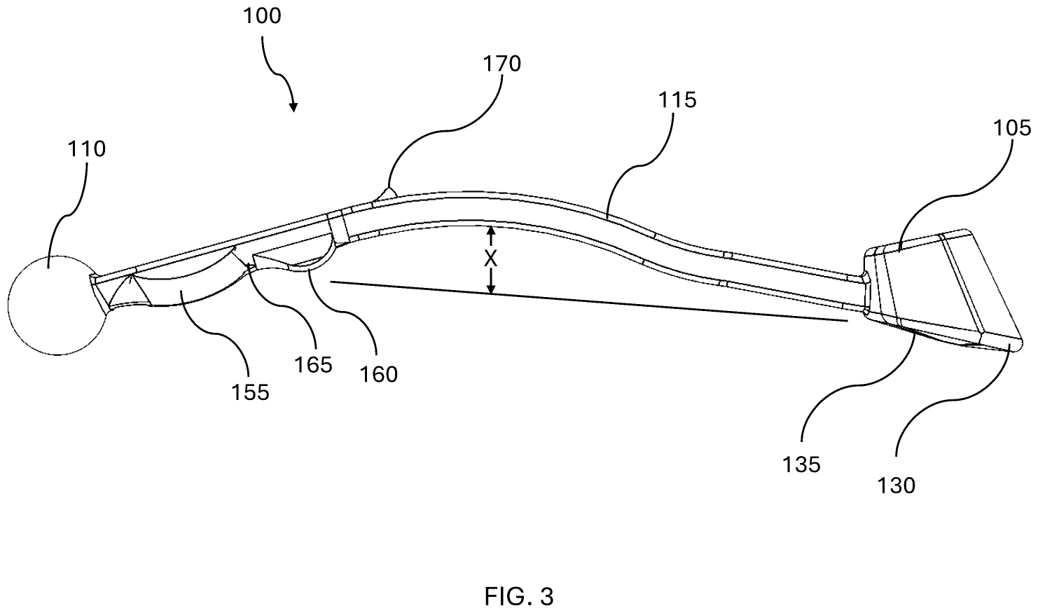

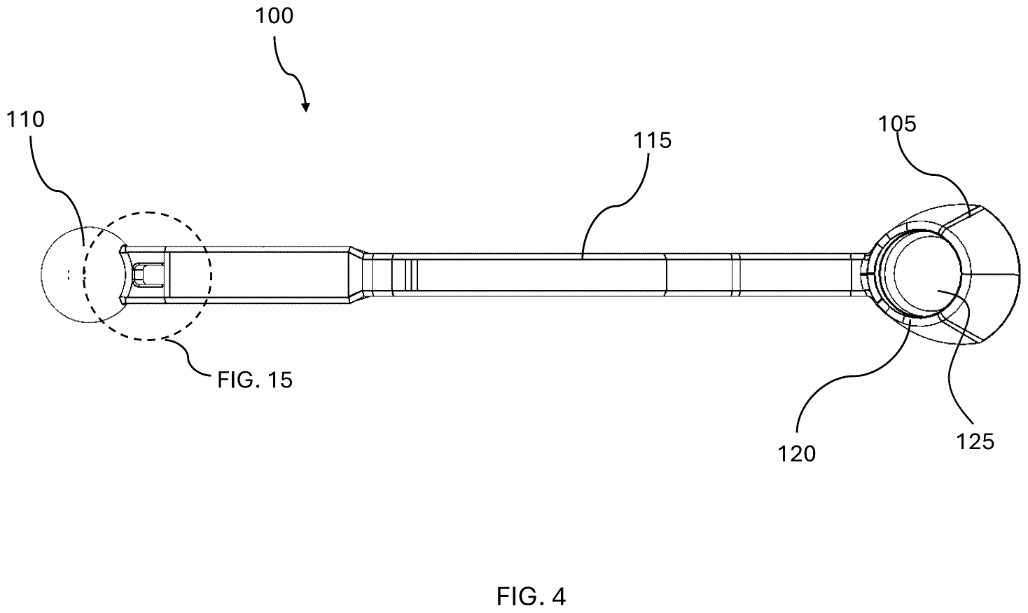

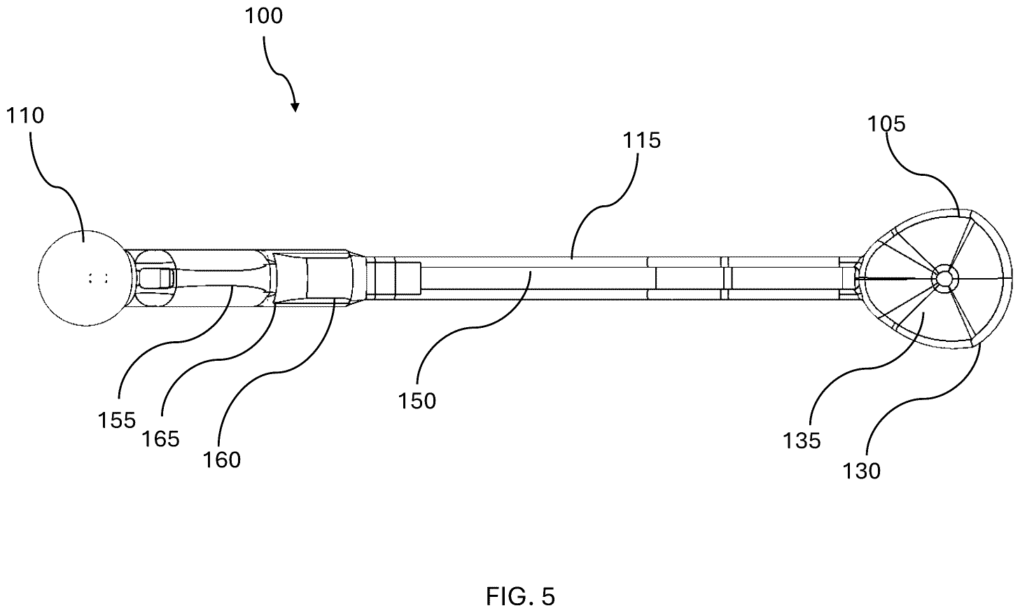

FIGS. 1 through 5 schematically illustrate various views of an exemplary embodiment of a personal care device 100. The personal care device is illustrated in FIG. 1 from a top-left perspective view, illustrated in FIG. 2 from a bottom-left perspective view, illustrated in FIG. 3 from a side view, illustrated in FIG. 4 from a top view, and illustrated in FIG. 5 from a bottom view. The personal care device 100 includes a head portion 105 positioned at one end of the device 100. As will be further describe herein, the head portion 105 includes two sides that can be used for different purposes and functions. The personal care device 100 includes a spherical feature 110 on an opposite end of the device 100 from the head portion 105. The head portion 105 and the spherical feature 110 are connected by an extended handle 115 with an ergonomic double-curved shape.

As noted above, the head portion 105 includes two sides that can be used for different purposes and functions. A first side 120 of the head portion 105 includes a generally cylindrical recess 125. A second side 130 of the head portion includes a generally flat surface 135. The cylindrical recess 125 of the first side 120 of the head portion 105 is arranged to secure one or more cylindrical products such as a “roll-on” product that is arranged to topically apply pain relief solution to a location on the individual's body. The flat surface 135 of the second side 130 is arranged such that a pad applicator can be removably or integrally secured to the flat surface 135, and a liquid, gel, cream, lotion, and other fluid substance can be applied to the pad applicator to facilitate topically applying the liquid, gel, cream, lotion, and other fluid substances to a location or region of the individual's body. In one example, the spherical feature 110 is arranged as a ball extending from the end of the personal care device 100, where the ball is integrally formed with the extending handle. In one example, the ball is approximately two inches in diameter. However, it will be understood that the ball or other spherical features can be of other sizes both larger than and smaller than two inches.

As best illustrated in FIG. 3, the extended handle 115 has an ergonomic double-curved shape and is arranged such that the personal care device 100 can be held and maneuvered by a user to position either the head portion 105 or the spherical feature 110 at a hard to reach or otherwise desirable location on the body. The extended handle 115 progresses in an upward curve from the spherical feature 110 toward the midpoint of the handle 115 (as viewed for the perspective of FIG. 3), and the extended handle 115 progresses in a downward curve from the midpoint of the handle 115 toward the head 105 of the personal care device 100 (as viewed for the perspective of FIG. 3). It will also be noted that the downward curve from the midpoint of the handle 115 toward the head 105 flattens out near the head 105 of the personal care device 100. This overall shape assists the user in using the personal care device 100. As is illustrated in FIG. 3, this shape creates a gap (with a height identified as reference symbol X). When using a pad adaptor attached to the flat surface 135 of the head 105 or the spherical ball 110, the gap X can be positioned over the shoulder or around the ribcage of a user so that the pad applicator or spherical feature 110 can better engage portions of the user's back. In one embodiment, the gap X is approximately 1.5 inches. It will be appreciated that when a roll-on applicator is used, a portion of the roll-on applicator extends out of the recess 125 of the head 105. Therefore the head 105 can be spaced apart from the body of the user when the personal care device 100 is used to apply medication and the like to the back of a user. In one embodiment, the extended handle 115 is arranged such that the head 105 and spherical feature 110 are approximately thirteen inches apart.

The extended handle 115 includes a first grip section 140 proximate to the head portion 105 and a second grip section 145 proximate to the spherical feature 110. If the user wants to engage the spherical feature 110 with a location on the body, the user grasps the personal care device 100 along the first grip section 140 and extends and maneuvers the spherical feature 110 until the spherical feature 110 is at the desired location on the body. If the user wants to apply a substance to a location on the body using a roll-on applicator or application pad, the user grasps the personal care device 100 along the second grip section 145 and maneuvers and extends the head portion 105 until the head portion 105 is at the desired location on the body. In certain embodiments, the extended handle 115 includes a channel 150 extending along the underside of the extended handle (as illustrated in FIGS. 2 and 5). The forming of such a channel 150 reduces the overall weight of the personal care device 100, which makes it easier for a user to manage and maneuver the personal care device 100 during use of the device 100. The channel 150 can be structured as a “c channel.” This is to say that the channel 150 includes two outer ribs that define the channel 150. Such a structure maintains the structural integrity of the extended handle 115 specifically and the personal care device 100 generally such that the device 100 maintains its shape during use of the device 100.

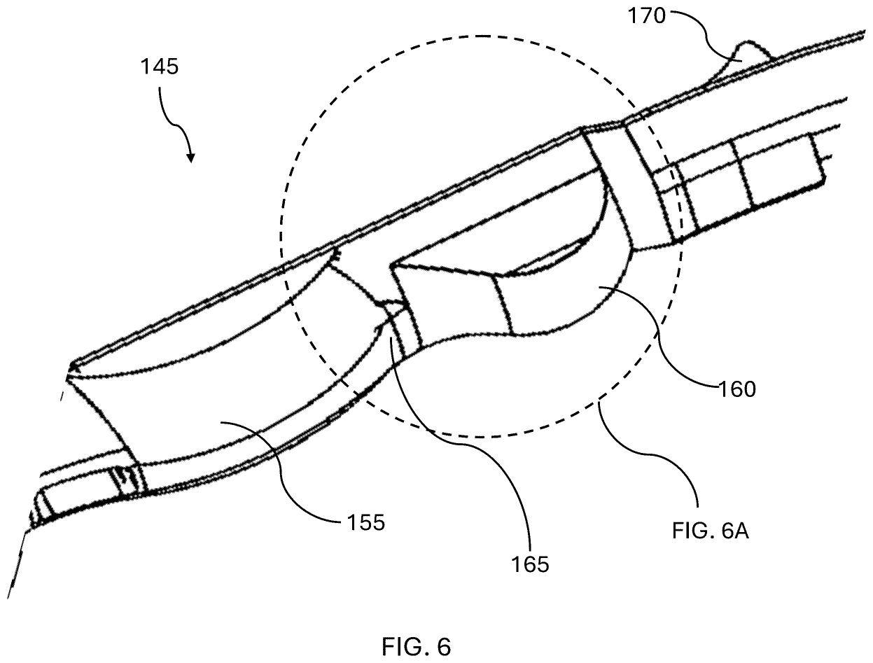

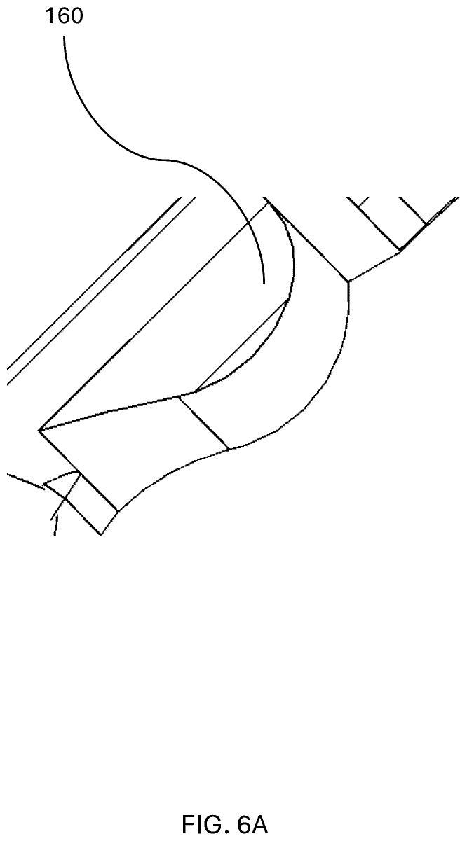

As illustrated in the figures, the second grip 145 section includes a number of grip features designed to enhance the user's ability to grasp, hold on to, and maneuver the personal care device 100 (grip features best illustrated in enhanced FIGS. 6 and 6A). In one example, the bottom side of the second grip section 145 includes a pair of raised areas (first raised area 155 and second raised area 160) and a recessed area 165 between the two raised areas (155, 160). The top side of the second grip section 145 includes a raised stop 170. When using the personal care device to apply a roll-on applicator secured in the recess 125, a user can grasp the second grip section 145 of the personal care device 100 by placing the bottom side of the second grip section 145 along the user's fingers, with the index finger positioned on one side of the second raised area 160 and the middle finger positioned in the recessed area 165 between the raised areas (155, 160). The additional fingers of the hand can be positioned on the first raised area 155, 160 and/or between the first raised area 160 and the spherical feature 110. The user can then curl his or her hand around the second grip section 150 and engage the user's thumb with the raised stop 170 on the top side of the second grip section 145 to further grasp, hold on to, and maneuver the personal care device 100. Once the user has secured the personal care device 100 in his or her hand, the user can maneuver the personal care device 100 to apply a substance to a location on the user's body with the roll-on applicator. In one embodiment the first raised area 155 spans the width of the extended handle 115 and includes a relatively low profile (as compared to the second raised area 160) rounded surface. The width of the second raised area 160 is less than the width of the extended handle 115 and includes a relatively high profile (as compared to the first raised area 155, and as illustrated in FIG. 6A) rounded surface. Although not illustrate in the figures, similar features to the raised areas (155, 160), recessed area 165, and raised feature 170 can be included on the opposite sides of the second grip section 145 to facilitate a user more securely grasping, holding on to, and maneuvering the personal care device 100 when utilizing a pad applicator to apply lotion, medication, and the like to a desired location on the body.

Similarly, the user can secure the personal care device 100 by engaging the first grip section 140 by wrapping his or her hand around the first grip section 140. In such an arrangement, the user can control and maneuver the personal care device 100 to position the spherical feature 110 at a desired location on the user's body and apply pressure to deliver acupressure or similar massage therapy to the desired location. One method of applying pressure to a desired location on the user's body is to manually apply pressure through the user's grip on the personal care device 100 and moving the spherical feature 110 over the location. Another method is to position the spherical feature 110 between the desired location on the user's body and another surface such as a back of a chair or a wall. In such an arrangement, the user can use the weight of his or her body and lean into the spherical feature 110 to regulate the amount of force or pressure applied to the desired location on the user's body and move their body to generally apply pressure across the desired location. Although not illustrate in the figures, similar features to the raised areas (155, 160), recessed area 165, and raised feature 170 can be included in the first grip section 140 to facilitate a user more securely grasping, holding on to, and maneuvering the personal care device 100 when utilizing the spherical feature 110 to apply acupressure or similar massage therapy to a desired location on the body.

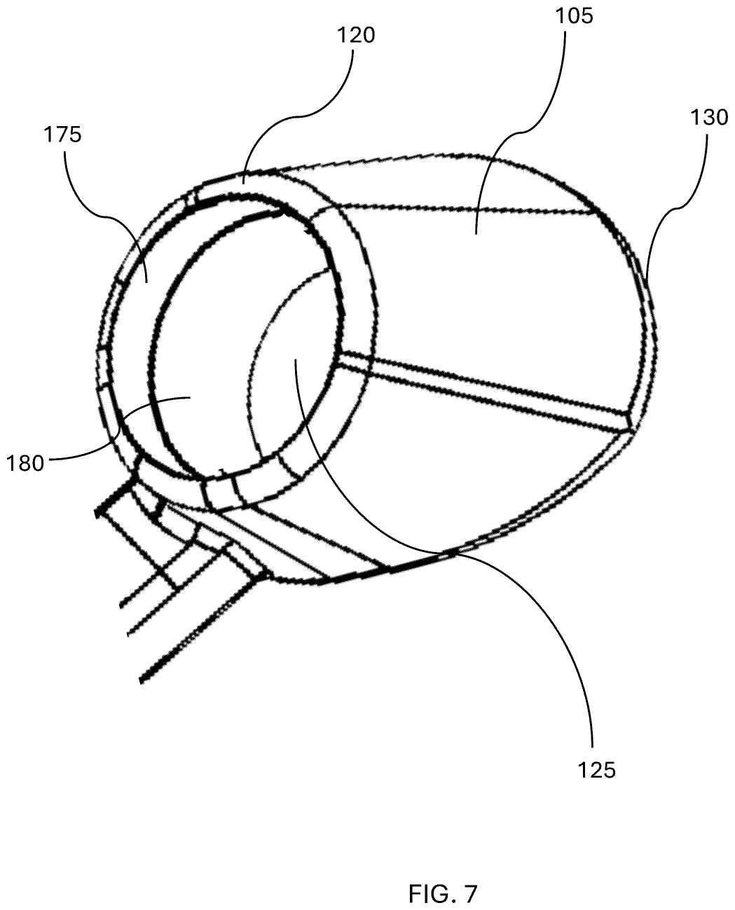

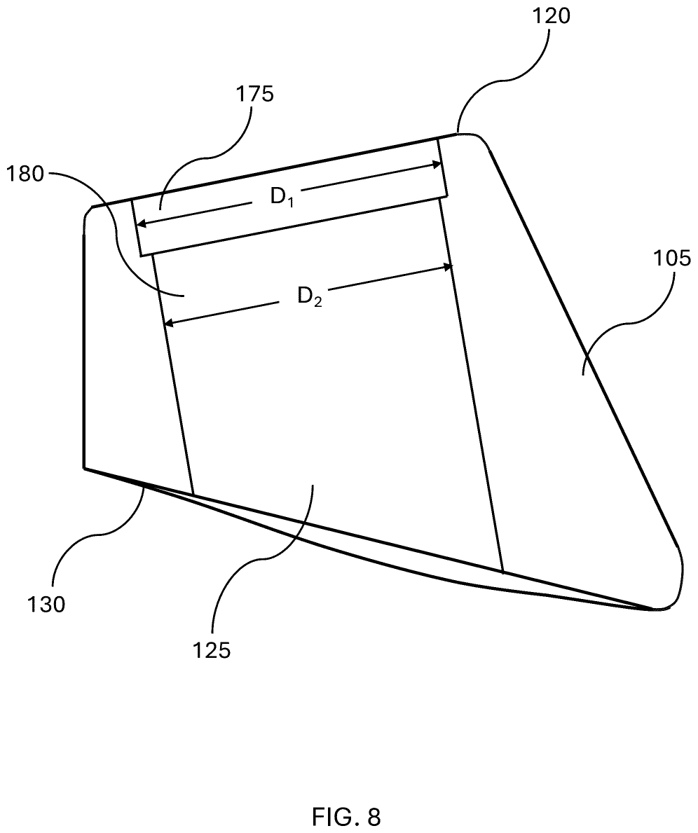

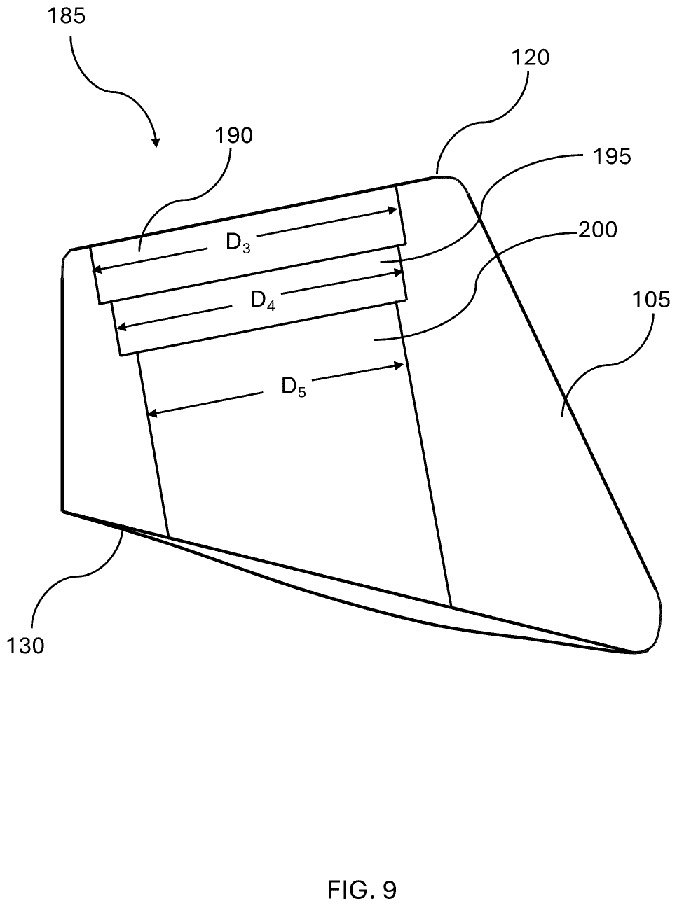

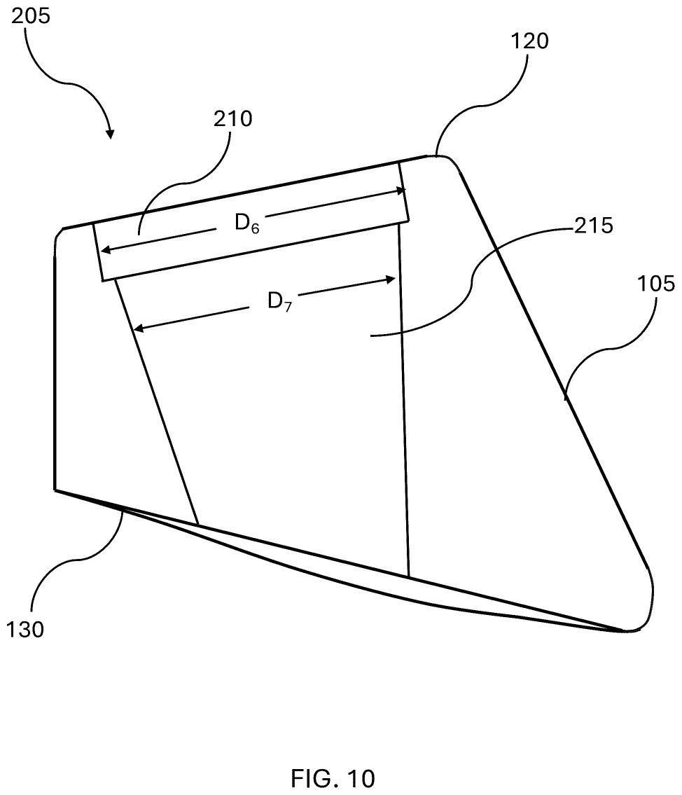

FIGS. 7-10 schematically illustrate three embodiments of a recess of first side 120 of the head portion 105 for securing a roll-on applicator to the personal care device 100. FIG. 7 schematically illustrates a top-left perspective view of the cylindrical recess 125 illustrated in FIGS. 1-5. FIG. 8 schematically illustrates a cross-sectional side view of the cylindrical recess 125 illustrated in FIG. 7 with two internal cylindrical sections (175, 180), each with a different diameter (D₁ and D₂). FIG. 9 schematically illustrates a cross-sectional side view of another embodiment of a cylindrical recess 185 of the first surface with three internal cylindrical sections (190, 195, 200), each with a different diameter (D₃, D₄, and D₅). FIG. 10 schematically illustrates a cross-sectional view of yet another embodiment that includes a recess 205 that includes an internal cylindrical section 210 with a specific diameter (D₆) and an internal conical section 215 extending downward for the cylindrical section that includes a variable diameter (D₇) that decreases from the top to the bottom of the conical section 215.

With reference to FIGS. 7 and 8, the cylindrical recess 125 is arranged to secure two different sizes of roll-on applicators useful in applying pain relief solutions. Roll-on applicators generally come in cylindrical shaped containers, but often come in different sizes, with 2.5 ounce and 3.0 ounce container being the general standard. The outer diameter of the standard 2.5 ounce roll-on applicator is smaller than the standard 3.0 ounce roll-on applicator. The first internal section 175 includes a first internal diameter (D₁) that is arranged to accept and secure a roll-on applicator with a matching external diameter. In one embodiment, the matching roll-on applicator is a 3.0 ounce roll-on applicator. The second internal section 180 includes a second internal diameter (D₂) that is arranged to accept and secure a roll-on applicator with a matching external diameter. In one embodiment, the matching roll-on applicator is a 2.5 ounce roll-on applicator. Such an arrangement provides for flexibility for the user. In certain circumstances, the user may desire to use a roll-on applicator with a larger external diameter, and the user can insert the roll-on applicator into the first internal section 175 to secure the roll-on applicator to the personal care device 100. In other circumstances, the user may desire to use a roll-on applicator with a smaller external diameter, and the user can insert the roll-on applicator into the second internal section 180 to secure the roll-on applicator to the personal care device 100. As will be appreciated, an arrangement of a cylindrical recess with two distinct diameters provides a useful tool to accommodate two common sizes of roll-on applicators.

FIG. 9 schematically illustrates a variation of the cylindrical recess 125 of FIGS. 7 and 8. This embodiment of a cylindrical recess 185 is arranged to secure three different sizes of roll-on applicator useful in applying a pain relief solution. In addition to the generally standard roll-on applicators sizes for 2.5 ounce and 3.0 ounce containers, there are other sized containers as well. In this embodiment, a first internal section 190 includes a third internal diameter (D₃) that is arranged to accept and secure a roll-on applicator with a matching external diameter. A second internal section 195 includes a second internal diameter (D₄) that is arranged to accept and secure a roll-on applicator with a matching external diameter. A third internal section 200 includes a fifth internal diameter (D₅) that is arranged to accept and secure a roll-on applicator with a matching external diameter. Such an arrangement provides for flexibility for the user. It also provides for flexibility for the designer of the personal care device 100. With three different internal diameters to work with, the designer can design the internal cylindrical section 185 to accommodate the common sizes of roll-on applicators (2.5 and 3.0 ounces) and one roll-on applicator with an external diameter that is larger or small than the two standard sizes. This is to say, D₃ of cylindrical recess 185 can be equal to D₁ of cylindrical recess 125, and D₅ of cylindrical recess 185 can be arranged to secure a roll-on applicator that has a smaller exterior diameter than the common 2.5 ounce version. Conversely, D₄ of cylindrical recess 185 can be equal to D₁ of cylindrical recess 125, and D₃ of cylindrical recess 180 can be arranged to secure a roll-on applicator that is larger than the common 3.0 ounce version. In addition to these examples, each of the diameters (D₃, D₄, D₅) of cylindrical recess 185 can be of different size from the diameters (D₁, D₂) of cylindrical recess 125 so as to accommodate three roll-on applicators (or other cylindrical contains) of three different sizes. Thus, with the arrangement illustrated in FIG. 9, the user can select from three differently sized cylindrical roll-on applicator for use with the personal care device 100, which provides a useful tool for the user. While FIGS. 7-9 illustrate two embodiments of a cylindrical recess for use with a personal care device 100, it will be understood that the principles demonstrate by these embodiments can be applied to other cylindrical recesses for use with a personal care device and such additional cylindrical recesses form part of this disclosure. For example, a cylindrical recess can include four internal sections, five internal sections, or more. And a cylindrical recess can include a single internal section.

FIG. 10 schematically illustrates another embodiment for arranging the first side 100 of the head portion 105 to secure roll-on applicators. In this embodiment, a recessed portion 205 is arranged to secure multiple different sizes of roll-on applicator useful in applying pain relief solutions. The recessed portion 205 includes a cylindrical section 210 and a conical section 215. The cylindrical section 210 includes a sixth diameter (D₆), and the conical section 215 includes a variable diameter (D₇). The variable diameter (D₇) of the conical section 215 progressively decreases from the bottom end of the cylindrical section 210 to the bottom end of the head portion 105. Such an arrangement provides for one size of roll-on applicator to be secured in the cylindrical section 210 (such as a 2.5 ounce, 3.0 ounce, or other sized roll-on applicator), and further provides for a variety of other sized roll-on applicators to be secured in the conical section 215. As will be appreciated, a roll-on applicator can be lowered into the conical section 215 until the outer diameter of the roll-on applicator matches the variable diameter (D₇) of the conical section 215. In one specific embodiment, D₆ can be equal to D₁ and arranged to secure a 3.0 ounce roll-on applicator and all smaller roll-on applicators are secured in the conical section 2215. In another embodiment, D₆ is larger than D₁ and arranged to secure a roll-on applicator with an outer diameter larger than a 3.0 ounce applicator. All other roll-on applicators are secured in the conical section 215. In another embodiment, the conical section extends from the top of the head portion 105 to the bottom of the head portion 105, with the cylindrical section eliminated. In yet another embodiment, a friction surface, such as a rubber coating or other elastomeric coating, can be applied to the conical section 215 to further secure a roll-on applicator inside the conical section 215.

In yet another embodiment, the personal care device 100 includes one or more cylindrical ring adapters. Such adapters can be arranged with an inner diameter that fits securely around the outer diameter of a roll-on applicator and an outer diameter that securely fits into one of the internal cylindrical sections of a cylindrical recess. In one embodiment, the cylindrical ring adaptor is made from rubber or other such elastomeric material. It will be appreciated that a set of such adaptors in combination with a personal care device can accommodate a significant number of roll-on applicators of varying sizes.

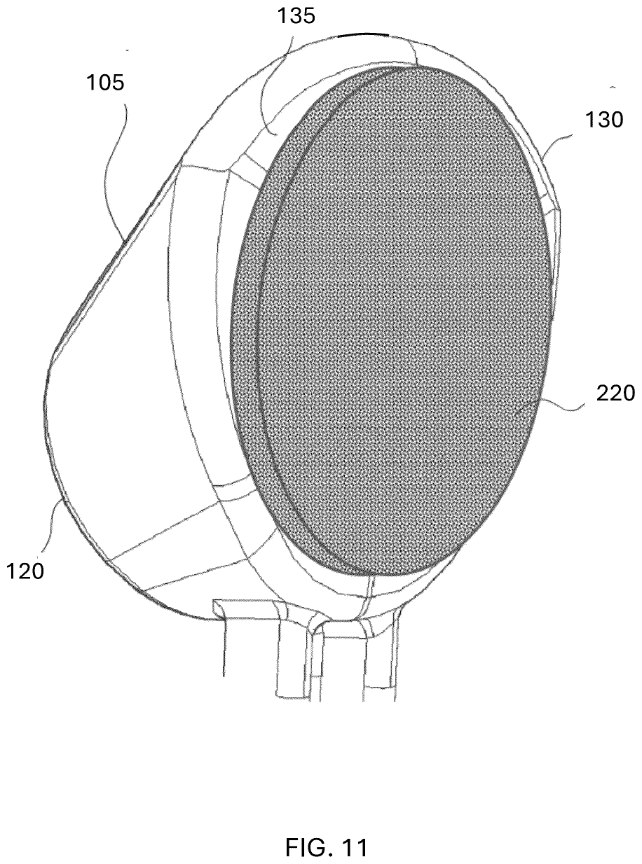

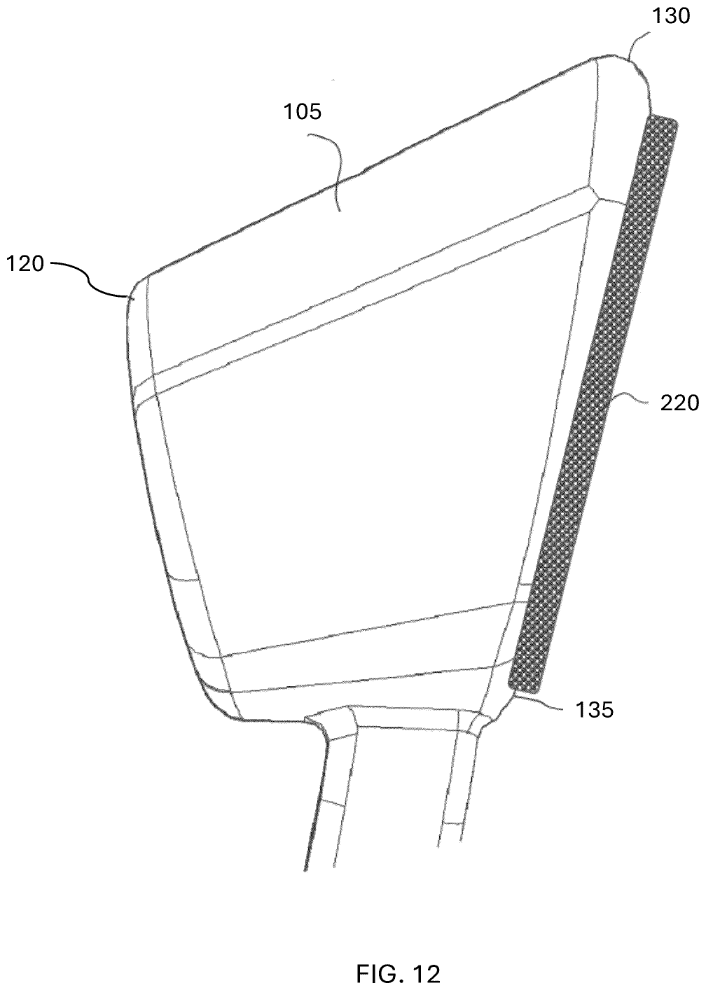

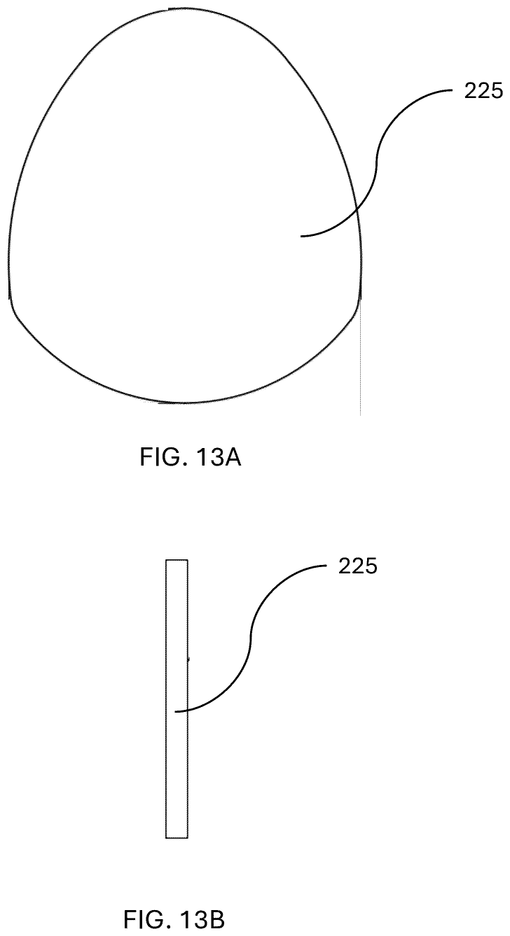

FIGS. 11 and 12 schematically illustrate a pad applicator 220 secured to the flat surface 135 of the head portion 105. FIG. 11 is a bottom-left perspective view, and FIG. 12 is a side view. A pad applicator 220 is a disposable component made from an absorbent material. Liquids, gels, creams, lotions, and other fluid substances can be applied to the pad applicator 220 and the pad applicator 220 will retain such substances until transferred to the body through contact with the body and mild applied pressure. The pad applicator 220 can be arranged with adhesive on its back side, where prior to use, the adhesive is covered by a thin sheet of non-stick plastic. The user can peel the thin plastic sheet from the adhesive on the back of the pad applicator 220 and secure the pad applicator 220 to the flat surface 135 of the head portion 105. Once the pad applicator 220 is secured, a liquid or gel, creams lotion, or other fluid substance such as pain relief solution, can be applied to the pad applicator 220 until sufficient pain relief solution is absorbed into the pad applicator 220. The user can then grasp the personal care device 100 by the second grip section 145, maneuver and extend the pad applicator 220 above the desired location on the body and apply the pain relief solution to the desired location with mild pressure and a dabbing or circular motion of the pad applicator 220. Once the task of applying pain relief solution to the desired location on the body is complete, the pad applicator 220 can be removed from the flat surface 145, and the pad applicator can be discarded. In another embodiment of a personal care device, the pad applicator is permanently attached to the head portion. In such an embodiment, the pad applicator is manufactured from a robust and tough absorbent material that can be repeatedly used and washed between uses. In yet another embodiment, the pad applicator can be a removeable but reuseable component. The flat surface can include a securing mechanism such as clips or fasteners that removably secure the pad applicator to the flat surface. The pad applicator is arranged such that it can be used, removed, washed, and reused numerous times. Such an embodiment can lead to cost savings over the service life of the personal care device. FIGS. 13A and 13B illustrate another embodiment of a pad applicator 225. FIG. 13A is a front view of the pad applicator 225, and FIG. 13B is a side view of the pad applicator 225. In this embodiment, the pad applicator 225 is shaped to generally match the flat surface 135 of the second side 130 of the head portion 105 of the personal care device 100. In one embodiment, the pad applicator 225 is approximately 2.5 inches in height, approximately 2.25 inches at its maximum width, and approximately 0.20 inches in thickness.

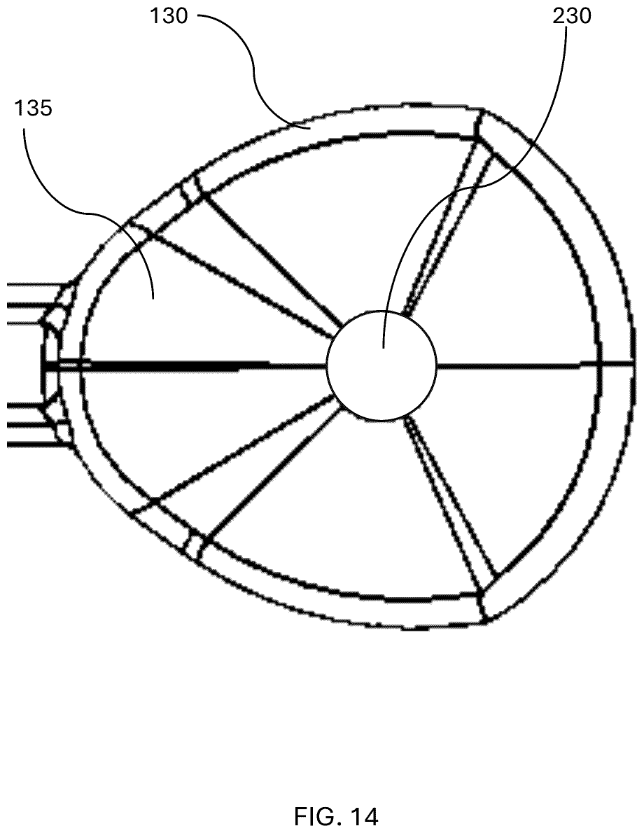

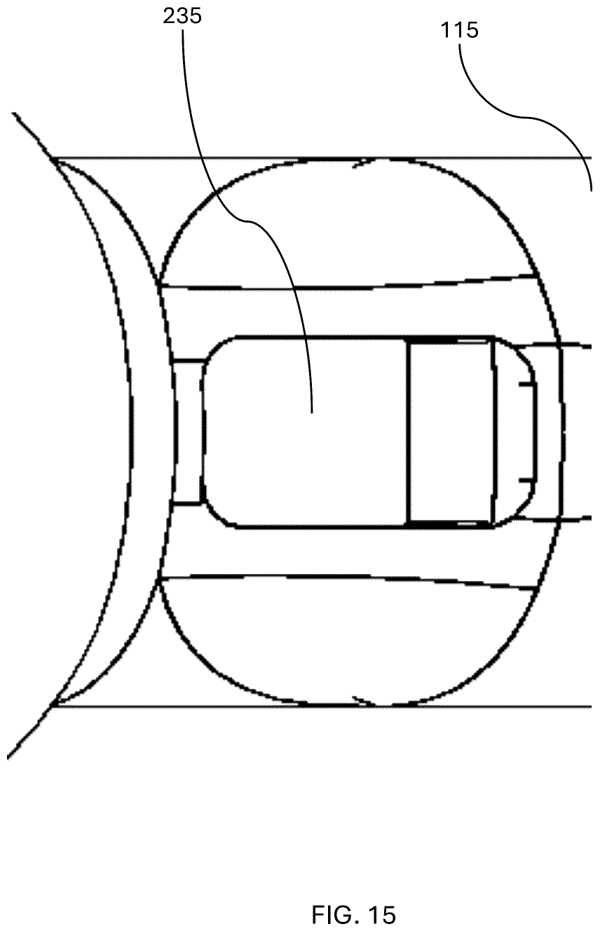

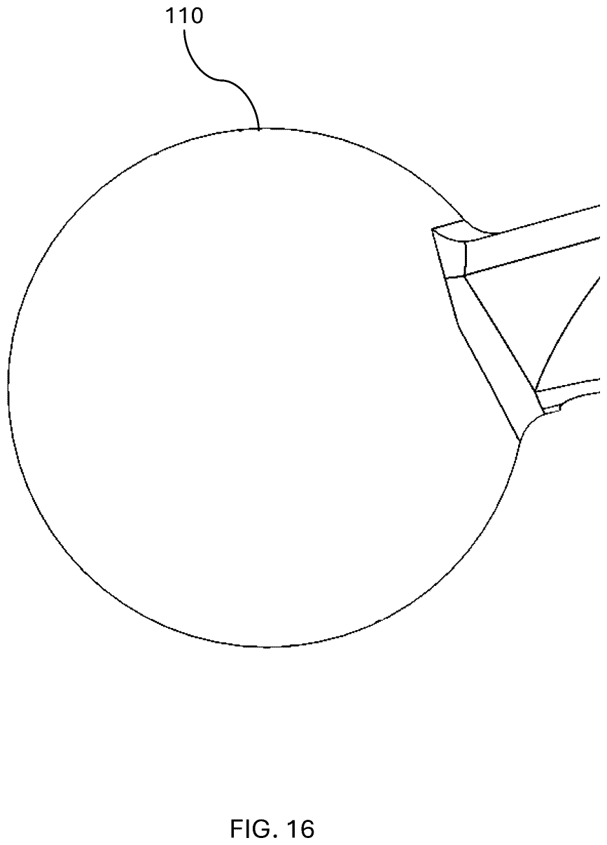

Additional embodiments of a personal care device 100 can include additional features. In one example, schematically illustrated in FIG. 14, the head portion 105 can include an aperture 230 in the flat surface 135 of the second side 130 of the head portion 105. Such an aperture 230 can assist in cleaning the personal care device 100 by allowing water of other cleansing fluids and solutions to drain out of the aperture 230. In another embedment, schematically illustrated in FIG. 15 (which is an enhanced view of a section of FIG. 4), the personal care device 100 includes a slot 235 in the extended handle 115. The slot 235 can be used to hang up the personal care device 100 when not in use. FIG. 16 is an enhanced perspective view of the spherical feature 110 extending from the end of the personal care device 100 opposite from the head portion 105. As is illustrated, the spherical feature 110 is a ball that is integrally incorporated into the extended handle 115 that extends beyond the extended handle 115 on all sides. Such an arrangement provides for a user to use the ball to apply pressure to a specific location on the body or to apply pressure along a section of the body by moving the ball along the region.

The personal care device 100 can be manufactured from any number of materials and by any number of manufacturing methods. For example, the personal care device can be made from a number of plastic resins, such as, for example, polyvinyl chloride (PVC), polypropylene (PP), polyethylene terephthalate (PET), polymethyl methacrylate (PMMA), high density polyethylene (HDPE), low density polyethylene (LDPE), acrylonitrile butadiene styrene (ABS), styrene acrylonitrile (SAN), Polystyrene (PS), or any combination thereof, to name a few. In some embodiment, the personal care device 100 can be manufactured from plastics that are generally considered or rated as medical grade or food-safe. Such materials can be arranged so that they are easier to clean and sterilize and resist the growth of microbes, bacteria, mold, and the like. One technique to minimize growth of harmful substances is to incorporate an anti-microbial additive in the plastic used to manufacture the personal care device. In one embodiment, the personal care device 100 is manufactured such that there is some flexibility in the extended handle 115. Such flexibility can be useful and helpful to a user apply the desired about of pressure when performing self-care tasks.

Methods of manufacturing a personal care device 100 from plastic resin include injection molding, blow molding, thermoforming, vacuum forming, compression molding, casting, and additive manufacturing (such as “3D printing”). In addition to manufacturing the personal care device 100 from a plastic material, the personal care device 100 can also be made from other materials such as metal. The personal care device 100 can be manufactured from a light-weight metal to form a robust and long lasting device. Such a personal care device can be manufactured using processes such as stamping, machining, and casting.

While most of the examples provide herein are directed to using a roll-on applicator, pad applicator, or the spherical feature, as noted above, the personal care device can additionally be arranged to perform a variety of other functions, including putting on socks and shoe; putting on or taking off a shirt or other clothing and garments; scratching one's back; brushing or combing one's hair; and retrieving items that are out of reach to the user. One method of adding the above listed functions as well as others is to include an attachment mechanism to one end of the personal care device. Such an attachment mechanism can be permanent attached or arranged to be removeable and attached and removed as required. The attachment mechanism can be arranged to secure, for example, any of the following features to one end of the personal care device: a sock aid to assist in putting on and removing socks; a shoe horn to assist with putting on shoes; a dressing apparatus to assist with putting on and removing garments; a back scratcher; a comb and brush adapter to assist with grooming of hair; and a grabber/reacher to retrieve out of reach items.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A personal care device comprising:
a head portion located at a first end of the device;
a spherical feature located at a second and opposite end of the device; and
a handle connecting the head portion and spherical feature.

2. The personal care device of claim 1, wherein:
the head portion comprises:
a first side with a generally cylindrical recess; and
a second and opposite side with a flat surface.

3. The personal care device of claim 2, wherein the cylindrical recess includes a first inner section with a first inner diameter and a second inner section with a second inner diameter.

4. The personal care device of claim 3, wherein the first inner diameter is of a different size than the second inner diameter.

5. The personal care device of claim 3, wherein the first inner section is arranged to secure at least a portion of a first object within the cylindrical recess.

6. The personal care device of claim 5, wherein the first inner section is arranged to secure at least a portion of the first object within the cylindrical recess with a friction fit.

7. The personal care device of claim 3, wherein the second inner section is arranged to secure at least a portion of a second object within the cylindrical recess.

8. The personal care device of claim 7, wherein the second inner section is arranged to secure at least a portion of the second object within the cylindrical recess with a friction fit.

9. The personal care device of claim 3, wherein the cylindrical recess includes a third inner section with a third inner diameter.

10. The personal care device of claim 9, wherein the third inner diameter is of a different size than the first inner diameter and the second inner diameter.

11. The personal care device of claim 9, wherein the third inner section is arranged to secure at least a portion of an object within the cylindrical recess.

12. The personal care device of claim 2, wherein the cylindrical recess includes a first inner section that is cylindrical in shape with a first inner diameter and a second inner section that is conical in shape.

13. The personal care device of claim 12, wherein the first inner section is arranged to secure at least a portion of a first object within the cylindrical recess and the second inner section is arranged to secure at least a portion of a second object within the cylindrical recess.

14. The personal care device of claim 2, wherein a pad applicator is secured to the flat surface of the head portion.

15. The personal care device of claim 9, wherein the pad applicator is removably secured to the flat surface using an adhesive.

16. The personal care device of claim 9, wherein the pad applicator is integrally incorporated into the head portion.

17. The personal care device of claim 1, wherein the spherical feature is a ball integrated into the handle.

18. The personal care device of claim 1, wherein the handle includes a double-curved shape with a first grip section located proximate to the head portion and a second grip section located proximate to the spherical feature.

19. The personal care device wherein the second grip section includes on a first surface a thumb stop to engage the thumb of a user.

20. The personal care device wherein the second grip section includes on a second surface a first raised area, a second raised area, and a recessed area between the first raised area and the second raised area.
